(19) United States
(12) Patent Application Publication
(10) Pub. No.: US 2011/0272506 A1
(43) Pub. Date: Nov. 10, 2011

(54) Blender for mixing or comminuting foodstuffs and method for operating a blender

(76) Inventors: Bernhard Boland, Frankfurt (DE); Thomas Steiner, Trebur (DE)

(21) Appl. No.: 13/187,722

(22) Filed: Jul. 21, 2011

Related U.S. Application Data
(63) Continuation-in-part of application No. PCT/IB2010/050359, filed on Jan. 27, 2010.

(30) Foreign Application Priority Data
Feb. 21, 2009 (EP) 09002495.1

(51) Int. Cl. B02C 19/00

(52) U.S. Cl. 241/25; 241/98

(57) ABSTRACT

The present invention relates to a blender, for example a hand blender, for mixing or comminuting foodstuffs in a work area of the blender. The blender comprises an illumination device for illuminating the work area, said illumination device being integrated in the blender. According to the invention the illumination device is designed to emit pulsed light signals in a stroboscopic manner in order to facilitate the observation of the mixing or comminuting procedure. The present invention further relates to a method for operating a blender having an illumination device for illuminating the work area.

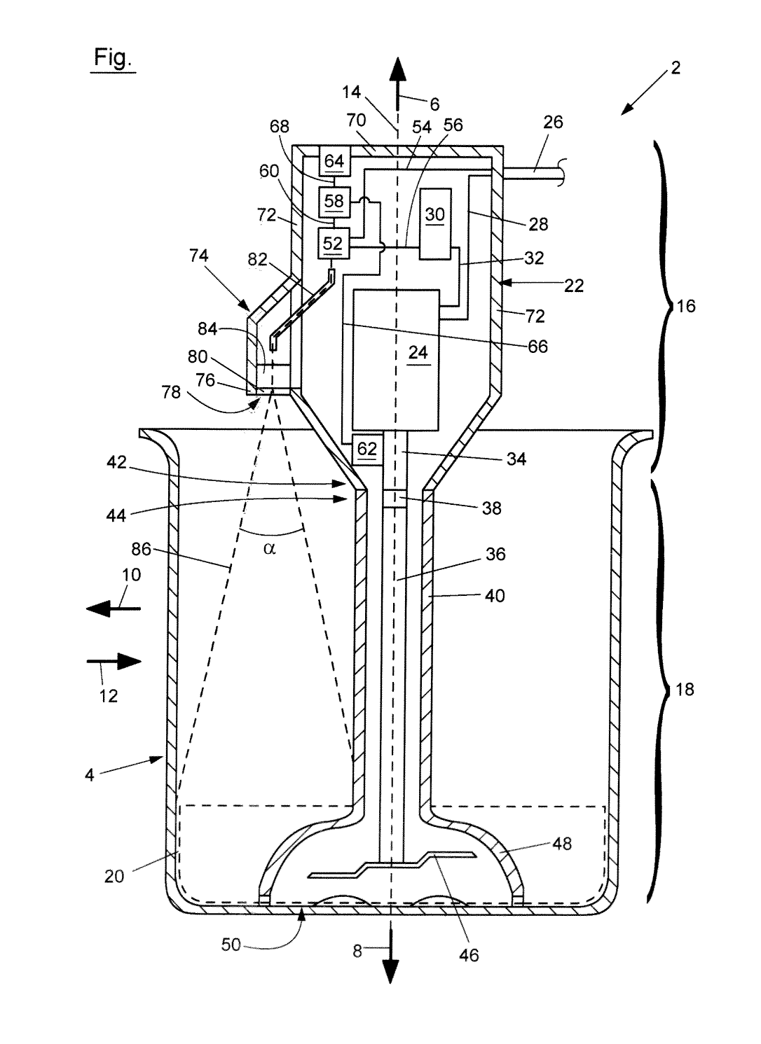

### CROSS REFERENCE TO RELATED APPLICATION

This application is a continuation-in-part of prior co-pending International Application No. PCT/IB2010/050359, filed Jan. 27, 2010 and designating the United Sates, the disclosure of which is incorporated herein by reference.

### FIELD OF THE INVENTION

The present invention relates to blender for mixing or comminuting foodstuffs in a work area of the blender comprising an illumination device for illuminating the work area, said illumination device being integrated in the blender. The present invention further relates to a method for operating a blender with an illumination device.

### BACKGROUND OF THE INVENTION

A plurality of domestic blenders, mixers or mixing devices for mixing or comminuting food-stuffs is already known from the state of the art. The known devices may be categorized into two broad classifications. The first category includes blenders of the stand type. They are usually used for mixing a large amount of material and have usually been used for kneading bread doughs and mixing other heavy foodstuffs. The second category includes blenders of the handheld type, the so-called hand blenders. The lightweight and portable hand blenders are usually used for mixing small amounts of material.

A blender of the stand type is for example disclosed in U.S. Pat. No. 4,277,181. The known food mixer has a stand with a base, a mixer head for mixing foodstuffs being pivotally mounted on the stand. Inside the mixer head there is provided an electrical motor for providing motive power to the whippers of the food mixer. The whippers of the known food mixer, which may also be referred to as the processing tools of the food mixer, are fixed to the mixer head and extend downward into the work area of the known food mixer. The food mixer further comprises an illumination device for illuminating the work area. The illumination device is integrated in the mixer head and comprises an incandescent lamp as a light source, said incandescent lamp being screwed into a socket inside the mixer head. The incandescent lamp is placed in a recess of the mixer head, said recess having an outlet opening which is directed to the work area. Thus, the light generated by the incandescent lamp may leave the recess via the outlet opening in order to illuminate the work area. Further, a frosted lens is mounted within the outlet opening, said frosted lens diffusing the light from the incandescent lamp to provide uniform lightning to the work area.

The known blender for mixing foodstuffs has proved itself insofar as the work area is well illuminated by the incandescent lamp. However, due to the high rotation frequency of the proceeding tools it is difficult for the user to observe the mixing procedure. Thus, it is necessary to stop the proceeding tools of the blender in order to detect the progress of the mixing procedure.

It is therefore an object of the present invention to provide a blender for mixing or comminuting foodstuffs in a work area of the blender, which allows an easy and comfortable observation of the mixing or comminuting procedure during the mixing or comminuting procedure. It is a further object of the present invention to specify a method for operating a blender for mixing or comminuting foodstuffs, said method simplifying the observation of the mixing or comminuting procedure during the mixing or comminuting procedure.

### SUMMARY OF THE INVENTION

The above-mentioned problem is solved by a blender and a method as described in claims 1 and 15, respectively. Embodiments of the invention are described in the sub-claims.

The present invention is directed to a blender for mixing or comminuting foodstuffs in a work area of the blender. The work area of the blender is an area in which the mixing or comminuting of the foodstuffs takes place. Thus, the work area may be the interior of a container in which the foodstuffs to be mixed or comminuted and the processing tools of the blender, e. g. a mixing tool or a cutter blade, are placed. The blender further comprises an illumination device for illuminating the work area. The illumination device is integrated in the blender. Thus, the illumination device may for example be placed inside the housing or a housing part of the blender. According to the invention the illumination device is designed to emit pulsed light signals in a stroboscopic manner. For example, the illumination device and its light source, respectively, is turned on and off in a flashlight-like manner. It is nevertheless also possible to block and deblock a permanent light of the illumination device in order to emit pulsed light signals in a stroboscopic manner.

If the work area is illuminated by pulsed light signals, the user does not have to see every single phase of the mixing or comminuting procedure. Instead, the user only perceives single pictures of the work area whenever a light signal is emitted to illuminate the work area. Thus, the continuous motion or transformation of the foodstuffs and/or the processing tool is represented by a series of short or instantaneous samples. This way, it is easier and more comfortable for the user to observe the comminuting or mixing procedure.

In an embodiment of the blender according to the invention the blender is designed as a hand blender and a handheld blender, respectively. In contrast to a stand type blender, a hand blender is handheld so that a sideward, upward or downward movement could not be avoided during the comminuting or mixing procedure. Such a movement of the hand blender may be desirable, especially when the foodstuffs to be mixed or comminuted is spread over a wide area. Thus, the observation of the work area is difficult. By providing a hand blender with the above described illumination device emitting pulsed light signals in a stroboscopic manner, the observation of the progress of the comminuting or mixing procedure could be facilitated.

In a further embodiment of the blender according to the invention the illumination device comprises a light source. This light source may for example be an incandescent lamp. However, it is difficult to turn on and off an incandescent lamp in a flashlight-like manner, so that a cover device has to be developed which blocks and deblocks the light of the incandescent lamp in order to emit pulsed light signals. An incandescent lamp needs a big installation space, so that the dimensions of the blender, especially the dimensions of a hand blender, have to be increased. In order to overcome these disadvantages, it is further possible to use a light-emitting diode as a light source for the illumination device. Further, in an embodiment the light source is formed by a series of light-emitting diodes, i. e. there are provided at least two single light-emitting diodes. By providing a series of light-emitting diodes it is for example possible to vary the color temperature or the light intensity of the light signals by choosing the light-emitting diode having the corresponding attributes. Further, it is possible to position the single light-emitting diodes in such a manner that the work area is completely illuminated by the illumination device.

In another embodiment of the blender according to the invention the light source of the illumination device is designed to be line-operated or the light source is designed to be operated off the line or battery-supplied. If the motor for rotating the processing tool of the blender is already line-operated, the light source should be line-operated too. If the motor for rotating the processing tool of the blender is already operated off the line or battery-supplied. the light source should be operated off the line or battery-supplied as well. In both cases, the motor and the light source use the same energy source.

In order to make the observation of the comminuting or mixing procedure more comfortable the pulsation frequency of the light signals may be altered in a further embodiment of the blender according to the invention. It is further possible that the pulsation frequency of the light signals could be automatically and/or manually altered. In the first case, the pulsation frequency may for example be coupled with the rotation frequency of the processing tool, so that a change of the rotation frequency is considered, as will be described below. In the second case, the user may manually alter the pulsation frequency in order to change the pulsation frequency according to his needs. It is also possible that the pulsation frequency may be automatically and manually altered in order to facilitate the handling of the blender on the one hand and to increase the flexibility of the blender on the other hand.

In a further embodiment of the blender according to the invention the blender comprises a rotatable processing tool, said processing tool in an embodiment being a mixing tool for mixing food-stuffs or a cutter blade for comminuting foodstuffs. The processing tool is placed in the work area in order to mix or comminute the foodstuffs in the work area. In this embodiment the pulsation frequency is coupled with the rotation frequency of the processing tool, i. e. if the rotation frequency is increased, the pulsation frequency is increased as well. If the rotation frequency is decreased, the pulsation frequency is decreased as well.

In a further embodiment of the blender according to the invention which is based on the afore described embodiment the pulsation frequency is coupled with the rotation frequency according to the formula Fₚ=Fᵣ/x, wherein Fₚ is the pulsation frequency, Fᵣ the rotation frequency of the processing tool and x is a number. In order to facilitate the observation of the comminuting or mixing procedure x may be greater than 1, i. e. x>1, and the pulsation frequency is lower than the rotation frequency.

In a further embodiment of the blender according to the invention the number x in the above-mentioned formula is an integral number. In other words, the rotation frequency is an integral multiple of the pulsation frequency. In this embodiment, the perceived single pictures of the work area, when a light signal is emitted to illuminate the work area, all show the work area when the processing tool is in the same rotational position. If the rotatable processing tool is for example not covered by the foodstuffs or a housing part of the blender, in this embodiment a fixed image of the rotating processing tool will be perceived. Thus, the successive pictures form an easy traceable animation of the transformation or motion of the foodstuffs in the work area, thereby facilitating the observation of the comminuting or mixing procedure.

It has been found out that an observation of the comminuting or mixing procedure could be further facilitated if a very low pulsation frequency is used. Thus, in a further embodiment of the blender according to the invention the number x in the above-mentioned formula is equal to or greater than 10 or 20, i. e. the rotation frequency is equal to or greater than ten times or twenty times the pulsation frequency. However, in this case in a further embodiment the number x is less than 500, in order to facilitate the observation of the comminuting or mixing procedure.

In another embodiment of the blender according to the invention the pulsation frequency or number x in the above-mentioned formula may be manually altered in a region between +/−20%. Thus, the flexibility of the blender is increased and the user may increase or decrease the pulsation frequency according to his needs. However, the pulsation frequency may still be coupled with the rotation frequency. If the relation between the pulsation frequency and the rotation frequency is for example 1 to 10. the user may decrease or increase the pulsation frequency so that said relation is changed. In this case, if the rotatable processing tool is not covered by the foodstuffs or a housing part of the blender, a pictorial representation of the processing tool which shows a slow rotation in one rotation direction or the other rotation direction can be achieved for the user, thereby facilitating observation of the progress of the comminuting or mixing procedure.

In a further embodiment of the blender according to the invention the light intensity of the light signals is alterable. Depending on the ambient light intensity and/or the used container for the foodstuffs, the work area is more or less illuminated by the ambient light. If for example the ambient light intensity is low and/or a container with opaque walls is used, it might be helpful to increase the light intensity of the emitted light signals. On the other hand, if the ambient light intensity is high and/or a container with translucent walls is used, the emitted light signals do not necessarily have to have a high light intensity, so that the light intensity of the light signals may be reduced. In this embodiment the light intensity of the light signals may manually and/or automatically altered. If the light intensity is automatically altered, a very comfortable handling of the blender is achieved. If the light intensity may be alternatively or additionally manually altered, the light intensity could be altered according to the individual needs of the user.

In another embodiment of the blender according to the invention which is based on the afore described embodiment the light intensity is automatically altered depending on the ambient light intensity. If the ambient light intensity is low, the light intensity of the emitted light signals will be automatically increased. If the ambient light intensity is high, the light intensity of the emitted light signals will be automatically decreased. As already mentioned above, a comfortable handling of the blender will be achieved since the user does not necessarily have to act in order to adapt the light intensity of the emitted light signals to the ambient light intensity. This automatic increase or decrease of the light intensity of the emitted light signals may for example be realized by integrating a sensor for sensing the ambient light intensity in the blender, which cooperates with a control unit of the illumination device.

In a further embodiment of the blender according to the invention the emitted light signal forms a light cone and the size of the light cone may be altered. In order to alter the size of the light cone, the top angle of the light cone may for example be altered. In this embodiment it is further possible to alter the size of the light cone by an optical unit and/or a reflector unit of the illumination device. This embodiment is useful when the blender is designed as a hand blender. While blenders of the stand type are usually used with containers having the same size, hand blenders could be used with containers having different sizes, especially different diameters. Thus, if a big container is used, it might be helpful to increase the size of the light cone so that a bigger part of the work area could be illuminated. On the other hand, if a small container for receiving the foodstuffs is used, so that the work area is already smaller, the size of the light cone could be decreased as well. It is apparent from the description above that a blender, such as a hand blender, according to this embodiment allows a flexible adaptation of the size of the light cone to the used container for receiving the foodstuffs to be mixed or comminuted. In order to alter the size of the light cone, there may for example be provided a manual control element at the blender.

In another embodiment of the blender according to the invention the illumination device is designed to emit light signals having different color temperatures. Said color temperatures may be manually or automatically alterable. By emitting light signals having different color temperatures it might be easier to observe the comminuting or mixing procedure depending on the color of the food-stuffs to be mixed or comminuted. If the color temperatures are manually alterable, the color temperature may be altered according to the individual needs of the user and according to the color of the foodstuffs to be mixed or comminuted, so that the observation is facilitated.

In another embodiment of the blender according to the invention the blender comprises an outlet opening for the light signals and the outlet opening is directed at the work area. Such an outlet opening may for example be provided in a wall of a housing of the blender in which the illumination device is accommodated. Further, such an outlet opening may for example have a ringlike shape in order to surround the longitudinal axis of the blender, so that an excellent illumination of the work area is achieved. Further, if the illumination device comprises a light guide, such as an optical fibre, said light guide may be positioned between the light source and the outlet opening for guiding the light signal from the light source to the outlet opening. If a light guide is used the light source does not have to be necessarily placed close to the outlet opening. Instead, the light source may be placed anywhere at or inside the blender. Thus, the size of the blender does not have to be increased since the available space could be used in an optimal way. This is especially of importance if the blender is a hand blender, which should not only be lightweight but also have small dimensions. When using a light guide, the light guide may be integrated into the wall of a housing of the blender in order to achieve a hand blender having small dimensions. This could for example be done by inlaying or inserting the light guide during injection molding of the housing of the blender.

In another embodiment of the blender according to the invention the blender comprises an upper portion, such as a housing, for example a motor housing for receiving the motor of the blender, serving as a handle and being located at a distance from the work area and a lower portion, such as a shaft housing for receiving the working shaft of the hand blender, extending into the work area, said working shaft may carry the processing tool, e. g. a mixing tool or a cutter blade, the illumination device being arranged in the upper portion. By arranging the illumination device in the upper portion, the illumination device is widely protected against contamination so that the illumination device may still fulfill its task even if parts of the mixed or comminuted foodstuffs are hurled upward from the work area during the mixing or comminuting procedure.

In a further embodiment of the blender according to the invention the upper portion comprises a radial protrusion, such as a radially protruding housing part. The illumination device is at least partially arranged inside the radial protrusion and/or the outlet opening is provided in the wall of the radially protruding housing part, wherein for example the outlet opening is provided in a lower wall of the radially protruding housing part. By arranging the illumination device inside the radial protrusion or by providing the outlet opening in the wall of the radially protruding housing part it is possible to illuminate a bigger part of the work area especially if the blender is designed as an elongated or rod-shaped hand blender. On the other hand, protection of the illumination device and the outlet opening, respectively, could be achieved which will be apparent from the following description of another embodiment.

In another embodiment of the blender according to the invention the outlet opening and/or the radial protrusion is positioned above the lower end of the upper portion. While the lower end of the upper portion is prone to contamination by foodstuffs being hurled upward during the mixing or comminuting procedure, the outlet opening and/or the radial protrusion in its upper position is widely protected against contamination. Thus, a secure illumination of the work area is warranted during the whole mixing or comminuting procedure.

The method for operating a blender, such as a hand blender, for mixing or comminuting foodstuffs in a work area of the blender according to the invention concerns a method for operating a blender comprising an illumination device for illuminating the work area, said illumination device being integrated in the blender. This blender may for example he a blender according to the invention as described above. According to the invention the illumination device is operated in a way so that it emits pulsed light signals in a stroboscopic manner. Concerning the advantages of the method it is referred to the advantages described in connection with the blender according to the invention, which apply accordingly. Further, the above described embodiments of the blender and their advantages apply accordingly to embodiments of the method.

### BRIEF DESCRIPTION OF THE DRAWINGS

An embodiment of the present invention will now be described, by way of example only, with reference to the drawings in which the only FIGURE shows a schematic cross-sectional side-view of a hand blender.

### DETAILED DESCRIPTION OF THE DRAWINGS

The FIGURE shows an embodiment of a hand blender 2 for mixing or comminuting foodstuffs (not shown) according to the invention, the foodstuffs being placed in a container 4. In the FIGURE, the opposing longitudinal directions 6, 8 and the opposing radial directions 10, 12 of the hand blender 2 are indicated by corresponding arrows.

The hand blender 2 is rod-shaped and stretches along a longitudinal axis 14, said longitudinal axis 14 running in the longitudinal directions 6. 8. The hand blender 2 comprises an upper portion 16 and a lower portion 18, the upper portion 16 widely having a larger diameter than the lower portion 18. While the lower portion 18 extends into the work area 20 of the hand blender 2, said work area 20 being indicated by a dashed line, the upper portion 16 is placed at a distance from the work area 20, i. e. the upper portion 16 is placed upwards in the longitudinal direction 6 and attached to the lower portion 18.

The upper portion 16 forms a housing 22 for receiving the motor 24 of the hand blender 2, said motor 24 being an electrical motor. Thus, in this case the housing 22 may also be referred to as a motor housing. The motor 24 is line-operated and/or battery-supplied. For this purpose, there is provided a power chord 26 leading from the outside of the housing 22 into the housing 22. An extension of the power chord 26 inside the housing 22 is indicated by a line 28 through which the motor 24 is supplied with power. Alternatively or additionally there may he provided a battery 30 inside the housing 22 for supplying the motor 24 with power. The battery 30 is then coupled to the motor 24 via another line 32 inside the housing 22.

The motor 24 comprises an output shaft 34, said output shaft 34 protruding downwards in the longitudinal direction 8 along the longitudinal axis 14. Thus, the longitudinal axis 14 may also be referred to as the rotation axis of the hand blender 2. The distal end of the output shaft 34 is coupled to a working shaft 36 via a coupling 38 so that a rotation of the output shaft 34 about the longitudinal axis 14 is transmitted to the working shaft 36 via coupling 38.

The working shaft 36 also extends downward in the longitudinal direction 8 along the longitudinal axis 14 and is received inside an elongated tubular shaft housing 40 of the lower portion 18 of the hand blender 2. The housing 22 and the shaft housing 40 are fixed to one another at the lower end 42 of the housing 22 and the upper end 44 of the shaft housing 40, respectively. At the lower or distal end of the working shaft 36 there is attached a processing tool 46 by a torque proof connection. Thus, the rotation of the outlet shaft 34 of the motor 24 may be transmitted to the processing tool 46 via the coupling 38 and the working shaft 36. The processing tool 46 is placed in the work area 20 and serves to mix or comminute the foodstuffs in the work area 20 inside the container 4. Thus, the processing tool 46 may be a mixing tool or cutter blade, the latter being shown in the FIGURE.

Due to the fact, that the processing tool 46 protrudes in the radial directions 10, 12, the lower part of the shaft housing 40 is formed by a bell-shaped casing 48 so that a collision between the rotatable processing tool 46 and the shaft housing 40 is avoided and the processing tool 46 is securely accommodated inside the bell-shaped casing 48. Further, the bell-shaped casing 48 comprises an opening 50 in the longitudinal direction 8 so that foodstuffs in the work area 20 may enter the interior of the bell-shaped casing 48 in order to be mixed or comminuted by the rotating processing tool 46.

There is further provided an illumination device (no reference sign) which is integrated in the hand blender 2. The illumination device is accommodated in housing 22 of the hand blender 2 and serves to illuminate the work area 20. The elements of the illumination device will be described hereinafter.

The illumination device inside the housing 22 comprises a light source 52, the light source 52 being formed by a light-emitting diode. However, the light source 52 may also be formed by a series of light-emitting diodes, i. e. by at least two light-emitting diodes. As indicated by the lines 54, 56 the light source 52 is designed to be line-operated or operated off the line and battery-supplied, respectively. The light source 52 is controlled by a control unit 58 of the illumination device, sending control signals via line 60 to the light source 52.

Further, the illumination device comprises a first sensor 62 and a second sensor 64, which are linked with the control unit 58 via corresponding lines 66, 68. The first sensor 62 is a sensor for detecting the rotation frequency Fᵣ of the motor 24, the output shaft 34 of the motor 24 and the processing tool 46, respectively. The second sensor 64 is a sensor for measuring the ambient light intensity, i. e. the light intensity in the environment of the hand blender 2. For this purpose, the second sensor 64 is provided at the upper wall 70 of housing 22 so that the second sensor 64 could not be blocked by the hand of the user, who normally grasps the side wall 72 of the housing 22 in order to use the housing 22 as the handle of the hand blender 2.

The housing 22 further comprises a radial protrusion formed by a radially protruding housing part 74. The housing part 74 protrudes in the radial direction 10. In the lower wall 76 of the radially protruding housing part 74 there is further provided an outlet opening 78 for the light signals generated inside the housing 22 by the light source 52. A translucent cover 80 is mounted inside the outlet opening 78 to preclude upwardly hurled foodstuffs from entering the housing 22. The translucent cover 80 may for example be a frosted lens. The outlet opening 78 is directed in the longitudinal direction 8 so that the emitted light signals are directed to the work area 20 of the hand blender 2. As can be seen form the FIGURE, the outlet opening 78, the axially protruding housing part 74 and its lower wall 76, respectively, are positioned in the longitudinal direction 6 above the lower end 42 of the housing 22. thereby preventing a contamination of the outlet opening 78 by upwardly hurled foodstuffs.

Alternatively, there may be provided a ringlike outlet opening 78, i. e. an outlet opening 78 having a ringlike shape, so that it surrounds the longitudinal axis 14 of the hand blender 2 and an excellent illumination of the work area 20 is achieved. In this case, the radially protruding housing part 74 should surround the upper portion 16 in a ringlike manner as well.

In order to guide the light of the light source 52 to the outlet opening 78, the illumination device further comprises a light guide 82, said light guide 82 may be an optical fibre. The light guide 82 is positioned between the light source 52 and the outlet opening 78. However, between the light guide 82 and the outlet opening 78 there is further provided an optical unit and/or a reflector unit 84 whose function will be described later. The optical unit and/or a reflector unit 84 and a part of the light guide 82 are accommodated inside the radially protruding housing part 74, so that the illumination device is at least partially arranged inside the radially protruding housing part 74. It is further possible to have the light guide 82 integrated into the side wall 72 of the housing 22 in order to reduce the dimensions of the hand blender 2 in the radial direction 10.

The illumination device is designed to emit pulsed light signals in a stroboscopic manner. In the shown embodiment, the light source 52 is turned on and off in a flashlight-like manner. Due to the fact that the work area 20 is illuminated by pulsed light signals, the user does not see every phase of the mixing or comminuting procedure. Instead, the user only perceives single pictures of the work area 20 whenever a light signal is emitted. Thus, the continuous motion or transformation of the foodstuffs and/or the processing tool 46 is represented by a series of short or instantaneous samples. This way, it is easier and more comfortable for the user to observe the comminuting or mixing procedure.

In the shown embodiment, the pulsation frequency Fₚ of the light signals may be automatically and manually altered.

In order to automatically alter the pulsation frequency Fₚ of the light signals the pulsation frequency Fₚ is coupled with the rotation frequency Fᵣ of the output shaft 34 and the processing tool 46, respectively. The first sensor 62 permanently detects the rotation frequency Fᵣ of the output shaft 34 of the motor 24 and sends the measured data via line 66 to the control unit 58 of the illumination device. In this connection it should be mentioned that the first sensor 62 does not necessarily have to measure the rotation frequency Fᵣ of the output shaft 34 and the processing tool 46, respectively, directly at the output shaft 34. The first sensor 62 may also detect a rotation frequency directly at another rotating part of the motor or transmission, said rotation frequency having a known relationship to the rotation frequency Fᵣ of the output shaft 34 and the processing tool 46, respectively. Simultaneously, the control unit 58 calculates the pulsation frequency Fₚ according to the formula Fₚ=Fᵣ/x, wherein x is a number equal to or greater than 1, and x may be an integral number.

Afterwards, the control unit 58 sends a corresponding control signal to the light source 52, so that the light source 52 emits pulsed light signals with the calculated pulsation frequency Fₚ. Thus, if the rotation frequency Fᵣ is increased or decreased the pulsation frequency will be increased or decreased as well. It has been found out that an observation of the comminuting or mixing procedure could be further facilitated if a very low pulsation frequency Fₚ is used. Thus, in the shown embodiment the number x of the above-mentioned formula is equal to or greater than 10 or 20.

In order to manually alter the pulsation frequency Fₚ there may be provided a manual control element (not shown) at the housing 22. Such a manual control element could be linked with the control unit 58 of the illumination device so that the pulsation frequency Fₚ or x of the above formula may be altered. In the shown embodiment the pulsation frequency Fₚ or x of the above formula may be manually altered in a region between +/−20%, so that the pulsation frequency could be altered according to the needs of the user to a sufficient extent without impeding the observation of the mixing or comminuting procedure.

In the shown embodiment, the second sensor 64 permanently measures the light intensity in the environment of the hand blender 2, i. e. the second sensor 64 measures the ambient light intensity. Then, the second sensor 64 sends the measured data via line 68 to the control unit 58 of the illumination device. If the measured ambient light intensity is low the control unit sends a corresponding control signal to the light source 52 via line 60 so that the light intensity of the light signals emitted by the light source 52 is increased. On the other hand, if the measured ambient light intensity is high the control unit sends a corresponding control signal to the light source 52 via line 60 so that the light intensity of the light signals emitted by the light source 52 is decreased. Thus, an automatic altering of the light intensity of the light signals emitted by the light source 52 is achieved so that the handling of the hand blender 2 is more comfortable.

Further, the light intensity of the light signals may alternatively or additionally be manually altered according to the individual needs of the user. For this purpose, there may be provided a manual control element (not shown) at the upper portion 16 and the housing 22, respectively, as well.

As can be seen from the FIGURE, the emitted light signal forms a light cone 86 which is indicated by dotted lines. The size of the light cone 86 may be altered with the help of the optical unit and/or reflector unit 84. However, it should be mentioned that the size of the light cone may alternatively be altered by moving the light source 52 and/or the light guide 82 relative to the outlet opening 78. In the shown embodiment, in order to alter the size of the light cone 86 the optical unit and/or reflector unit 84 could be adjusted in a way that the top angle a of the light cone 86 is altered. This embodiment is especially useful when the blender is designed as the shown hand blender 2. While blenders of the stand type are usually used with containers having the same size, hand blenders 2 could be used with containers 4 having different sizes, especially different diameters. Thus, if a big container 4 is used it might be helpful to increase the size of the light cone 86 so that a bigger part of the work area 20 could be illuminated. On the other hand, if a small container 4 for receiving the foodstuffs is used, so that the work area 20 is already smaller, the size of the light cone 86 could be decreased as well. Thus, the hand blender 2 according to the shown embodiment allows a flexible adaptation of the size of the light cone 86 to the used container 4.

The illumination device is further designed to emit light signals having different color temperatures. The color temperatures could further be manually or automatically altered.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A blender for mixing or comminuting foodstuffs in a work area of the blender comprising an illumination device for illuminating the work area, said illumination device being integrated in the blender, and further said illumination device is designed to emit pulsed light signals in a stroboscopic manner.

2. The blender according to claim 1 wherein the illumination device comprises a light source being formed by at least one light-emitting diode.

3. The blender according to claim 2 wherein the light source of the illumination device is designed to be line-operated or in that the light source is designed to be operated off the line or battery-supplied.

4. The blender according to claim 1 wherein the pulsation frequency (Fₚ) of the pulsed light signals is alterable.

5. The blender according to claim 4 wherein the blender further comprises a rotatable processing tool placed in the work area, wherein further the pulsation frequency (Fₚ) is coupled with the rotation frequency (Fᵣ) of the processing tool.

6. The blender according to claim 5 wherein the pulsation frequency (Fₚ) is coupled with the rotation frequency (Fᵣ) according to the formula
Fₚ=Fᵣ/x,
wherein Fₚ is the pulsation frequency, Fᵣ is the rotation frequency of the processing tool and x is a number equal to or greater than 1.

7. The blender according to claim 6 wherein the pulsation frequency (Fₚ) or x is manually alterable in a region between +/−20%.

8. The blender according to claim 1 wherein the light intensity of the pulsed light signals is alterable.

9. The blender according to claim 1 wherein the emitted light signal forms a light cone.

10. The blender according to claim 1 wherein the illumination device is designed to emit light signals having different color temperatures.

11. The blender according to claim 1 wherein the blender comprises an outlet opening for the light signals, said outlet opening being directed at the work area, the illumination device further comprising a light guide.

12. The blender in the form of a hand blender according to claim 1 wherein the blender comprises an upper portion which is a housing serving as a handle and being located at a distance from the work area and a lower portion for receiving the working shaft of the hand blender and extending into the work area, wherein the illumination device is arranged in the housing.

13. The hand blender according to claim 12 wherein the upper portion housing comprises a radial protrusion, the illumination device being at least partially arranged inside said radial protrusion.

14. The hand blender according to claim 13 wherein said radial protrusion is positioned above the lower end of the upper portion housing.

15. A method for operating a blender for mixing or comminuting foodstuffs in a work area of the blender, said blender comprising an illumination device integrated in the blender for illuminating the work area, said method comprising the step of operating the blender so that the illumination device emits pulsed light signals in a stroboscopic manner.
